(19) United States
(12) Patent Application Publication
(10) Pub. No.: US 2021/0331559 A1
(43) Pub. Date: Oct. 28, 2021

(54) COMMUNICATION INTERFACE MODULE FOR ENERGY MANAGEMENT

(71) Applicant: Carrier Corporation, Palm Beach Gardens, FL (US)

(72) Inventor: Gael Ducher, Le Mesnil Esnard (FR)

(21) Appl. No.: 16/479,877

(22) PCT Filed: Jan. 20, 2017
(86) PCT No.: PCT/IB2017/000146

§ 371 Date: Jul. 22, 2019

(51) Int. Cl. B60H 1/32; B60H 1/00; B60W 10/30; B60L 1/00

(52) U.S. Cl. CPC B60H 1/3208; B60H 1/3232; B60H 1/3222; B60H 1/00428; B60W 10/30; B60W 2710/305; B60H 2001/3266; B60H 2001/327; B60W 2520/105; B60W 2710/248; B60L 1/003

(57) ABSTRACT

A transport refrigeration system (200) is provided comprising: a vehicle (102) integrally connected to a transport container (106); an engine (320) configured to power the vehicle; a refrigeration unit (22) configured to provide conditioned air to the transport container; a battery (350) configured to provide electrical power to the refrigeration unit; an electric generation device (340) operably connected to the engine (320) and configured to engage the engine and generate electrical power from the engine to charge the battery when the electric generation device is activated; a sensor system (360) configured to detect at least one of a deceleration of the vehicle (364), a downward pitch of the vehicle (366), and a high-efficiency rotational speed of the engine (362); and a communication interface module (310) configured to activate the electric generation device when the sensor system detects at least one of the deceleration of the vehicle, the downward pitch of the vehicle, and the high-efficiency rotational speed of the engine.

### BACKGROUND

The embodiments herein generally relate to transport refrigeration systems and more specifically, the energy management of such transport refrigeration systems.

Typically, cold chain distribution systems are used to transport and distribute cargo, or more specifically perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated vehicles and trailers are commonly used to transport perishable goods in a cold chain distribution system. A transport refrigeration system is mounted to the vehicles or to the trailer in operative association with a cargo space defined within the vehicles or trailer for maintaining a controlled temperature environment within the cargo space.

Conventionally, transport refrigeration systems used in connection with refrigerated vehicles and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

On commercially available transport refrigeration systems used in connection with refrigerated vehicles and refrigerated trailers, the compressor, and typically other components of the transport refrigeration unit, must be powered during transit by a prime mover. In mechanically driven transport refrigeration systems the compressor is driven by the prime mover, either through a direct mechanical coupling or a belt drive, and other components, such as the condenser and evaporator fans are belt driven. Transport refrigeration systems may also be electrically driven. In an electrically driven transport refrigeration system, a prime mover carried on and considered part of the transport refrigeration system, drives an AC synchronous generator that generates AC power. The generated AC power is used to power an electric motor for driving the refrigerant compressor of the transport refrigeration unit and also powering electric AC fan motors for driving the condenser and evaporator motors and electric heaters associated with the evaporator. A more efficient method to power the electric motor is desired to reduce fuel usage.

### BRIEF DESCRIPTION

According to one embodiment, a transport refrigeration system is provided. The transportation refrigeration system comprising: a vehicle integrally connected to a transport container; an engine configured to power the vehicle; a refrigeration unit configured to provide conditioned air to the transport container; a battery configured to provide electrical power to the refrigeration unit; an electric generation device operably connected to the engine and configured to engage the engine and generate electrical power from the engine to charge the battery when the electric generation device is activated; a sensor system configured to detect at least one of a deceleration of the vehicle, a downward pitch of the vehicle, and a high-efficiency rotational speed of the engine; and a communication interface module in electrical communication with at least one of the battery, the electric generation device, the engine, and the sensor system; wherein the communication interface module activates the electric generation device when the sensor system detects at least one of the deceleration of the vehicle, the downward pitch of the vehicle, and the high-efficiency rotational speed of the engine.

In addition to one or more of the features described above, or as an alternative, further embodiments of the transport refrigeration system may include a hydraulic pump operably connecting the electric generation device to the engine.

In addition to one or more of the features described above, or as an alternative, further embodiments of the transport refrigeration system may include that the electric generation device is operably connected to the engine through at least one mechanical linkage configured to rotate the electric generation device as the engine rotates when the electric generation device is activated.

In addition to one or more of the features described above, or as an alternative, further embodiments of the transport refrigeration system may include that: the sensor system further comprises a vehicle pitch sensor, the vehicle pitch sensor being configured to detect a pitch angle of the vehicle; and the communication interface module is configured to activate the electric generation device when the pitch angle is less than a selected pitch angle.

In addition to one or more of the features described above, or as an alternative, further embodiments of the transport refrigeration system may include that: the sensor system further comprises a vehicle deceleration sensor, the vehicle deceleration sensor being configured to detect a deceleration of the vehicle; and the communication interface module is configured to activate the electric generation device when the deceleration is greater than a selected deceleration.

In addition to one or more of the features described above, or as an alternative, further embodiments of the transport refrigeration system may include that: the sensor system further comprises an engine rotational speed sensor, the engine rotational speed sensor being configured to detect a rotational speed of the engine; and the communication interface module is configured to activate the electric generation device when the rotational speed is greater than a selected rotational speed.

In addition to one or more of the features described above, or as an alternative, further embodiments of the transport refrigeration system may include: a vehicle battery electrically connected to the power generation device, the vehicle battery being configured to store electrical power generated by the power generation device and charge the battery through a voltage converter, wherein the voltage convertor is configured to step-up the electrical power from a first voltage of the vehicle battery to a second voltage of the battery.

According to another embodiment, a method of operating a transport refrigeration system comprising a vehicle integrally connected to a transport container is provided. The method comprising: powering a refrigeration unit using a battery, the refrigeration unit being configured to provide conditioned air to the transport container; charging the battery using an electric generation device operably connected to an engine of the vehicle, the electric generation device configured to engage the engine and generate electrical power from the engine to charge the battery when the electric generation device is activated; detecting, using a sensor system, at least one of a deceleration of the vehicle, a downward pitch of the vehicle, and a high-efficiency rotational speed of the engine; and activating, using a communication interface module, the electric generation device when the sensor system detects at least one of the deceleration of the vehicle, the downward pitch of the vehicle, and the high-efficiency rotational speed of the engine; wherein the communication interface module in electrical communication with at least one of the battery, the electric generation device, the engine, and the sensor system.

In addition to one or more of the features described above, or as an alternative, further embodiments of the method may include transferring rotational energy from the engine to the electric generation device through a hydraulic pump when the electric generation device is activated.

In addition to one or more of the features described above, or as an alternative, further embodiments of the method may include transferring rotational energy from the engine to the electric generation device through at least one mechanical linkage configured to rotate the electric generation device as the engine rotates when the electric generation device is activated.

In addition to one or more of the features described above, or as an alternative, further embodiments of the method may include: detecting a pitch angle of the vehicle using a vehicle pitch sensor; and activating, using the communication interface module, the electric generation device when the pitch angle is less than a selected pitch angle.

In addition to one or more of the features described above, or as an alternative, further embodiments of the method may include: detecting a deceleration of the vehicle using a vehicle deceleration sensor; and activating, using the communication interface module, the electric generation device when the deceleration is greater than a selected deceleration.

In addition to one or more of the features described above, or as an alternative, further embodiments of the method may include: detecting a rotational speed of the engine using an engine rotational speed sensor; and activating, using the communication interface module, the electric generation device when the rotational speed is greater than a selected rotational speed.

In addition to one or more of the features described above, or as an alternative, further embodiments of the method may include that the battery is charged through a vehicle battery electrically connected to the power generation device and a power convertor, the vehicle battery being configured to store electrical power generated by the power generation device and the voltage convertor being configured to step-up the electrical power from a first voltage of the vehicle battery to a second voltage of the battery.

According to another embodiment, a computer program product tangibly embodied on a computer readable medium is provided. The computer program product including instructions that, when executed by a processor, cause the processor to perform operations comprising: powering a refrigeration unit using a battery, the refrigeration unit being configured to provide conditioned air to a transport container; charging the battery using an electric generation device operably connected to an engine of a vehicle integrally connected to the transport container, the electric generation device configured to engage the engine and generate electrical power from the engine to charge the battery when the electric generation device is activated; detecting, using a sensor system, at least one of a deceleration of the vehicle, a downward pitch of the vehicle, and a high-efficiency rotational speed of the engine; and activating, using a communication interface module, the electric generation device when the sensor system detects at least one of the deceleration of the vehicle, the downward pitch of the vehicle, and the high-efficiency rotational speed of the engine; wherein the communication interface module in electrical communication with at least one of the battery, the electric generation device, the engine, and the sensor system.

In addition to one or more of the features described above, or as an alternative, further embodiments of the computer program may include that the operations further comprise: transferring rotational energy from the engine to the electric generation device through a hydraulic pump when the electric generation device is activated.

In addition to one or more of the features described above, or as an alternative, further embodiments of the computer program may include that the operations further comprise: transferring rotational energy from the engine to the electric generation device through at least one mechanical linkage configured to rotate the electric generation device as the engine rotates when the electric generation device is activated.

In addition to one or more of the features described above, or as an alternative, further embodiments of the computer program may include that the operations further comprise: detecting a pitch angle of the vehicle using a vehicle pitch sensor; and activating, using the communication interface module, the electric generation device when the pitch angle is less than a selected pitch angle.

In addition to one or more of the features described above, or as an alternative, further embodiments of the computer program may include that the operations further comprise: detecting a deceleration of the vehicle using a vehicle deceleration sensor; and activating, using the communication interface module, the electric generation device when the deceleration is greater than a selected deceleration.

In addition to one or more of the features described above, or as an alternative, further embodiments of the computer program may include that the operations further comprise: detecting a rotational speed of the engine using an engine rotational speed sensor; and activating, using the communication interface module, the electric generation device when the rotational speed is greater than a selected rotational speed.

Technical effects of embodiments of the present disclosure include bleeding of rotational energy of a vehicle engine to generate electricity and power a refrigeration unit battery without adversely affecting vehicle performance.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1a is a schematic illustration of a transport refrigeration system, according to an embodiment of the present disclosure;

FIG. 1b is a schematic illustration of an alternative energy management system for the transport refrigeration system illustrated in FIG. 1a, according to an embodiment of the present disclosure;

FIG. 2 is an enlarged schematic illustration of a refrigeration unit of the transport refrigeration system of FIGS. 1a and 1b, according to an embodiment of the present disclosure; and

FIG. 3 is a flow process illustrating a method of operating the transport refrigeration system of FIGS. 1a, 1b, and 2 comprising a vehicle integrally connected to a transport container, according to an embodiment of the present disclosure.

### DETAILED DESCRIPTION

A detailed description of one or more embodiments of the disclosed apparatus and method are presented herein by way of exemplification and not limitation with reference to the Figures.

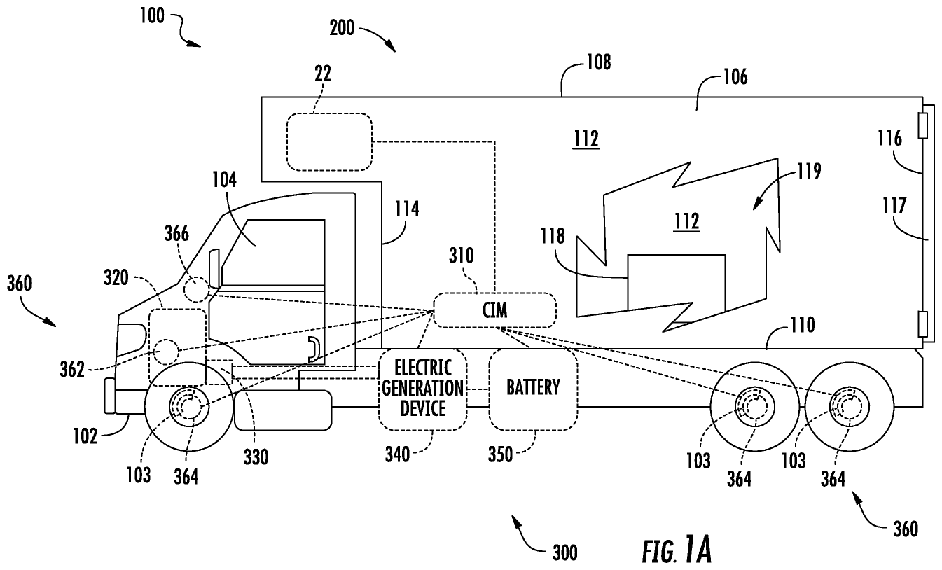

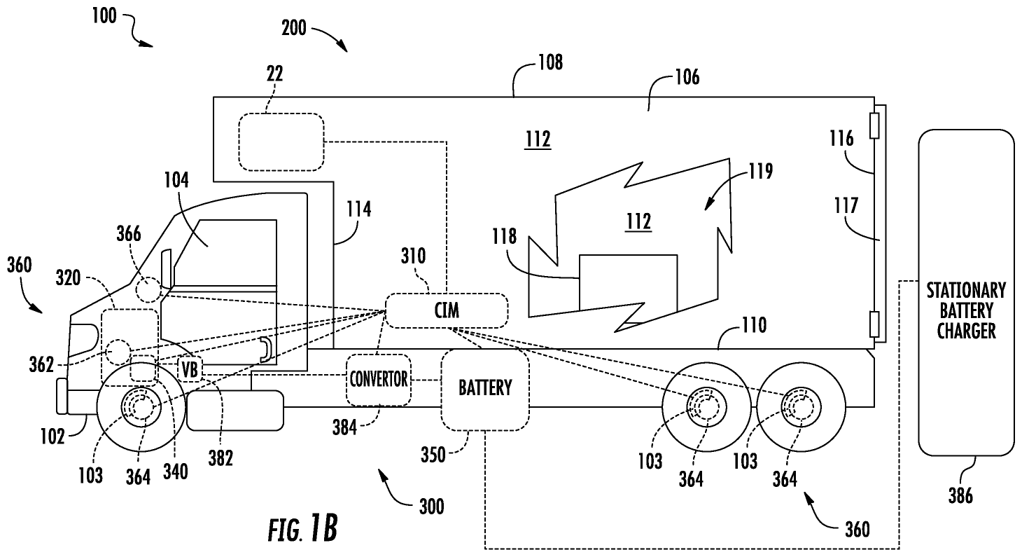

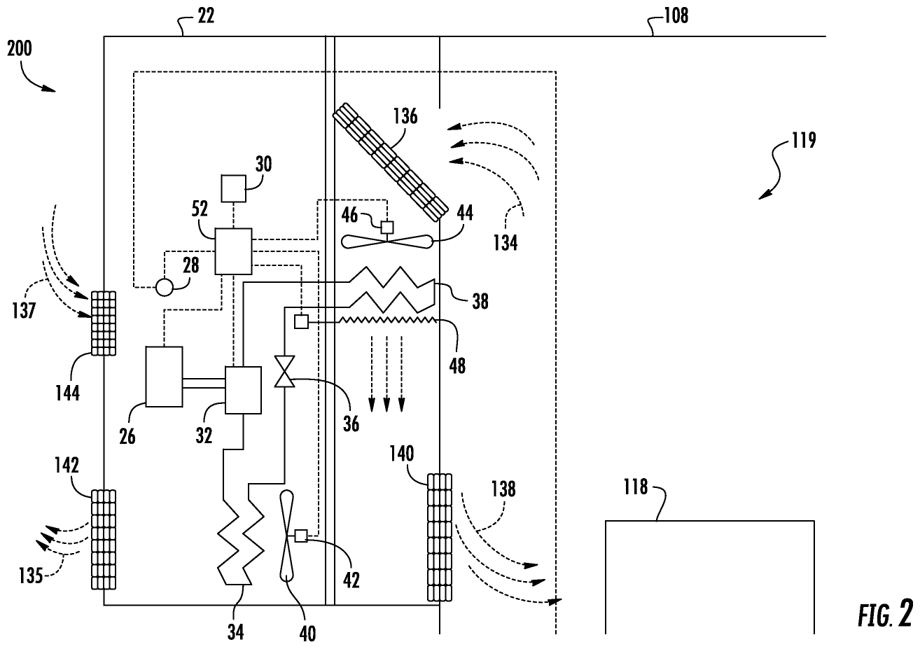

Referring to FIGS. 1a, 1b, and 2, various embodiments of the present disclosure are illustrated. FIG. 1a shows a schematic illustration of a transport refrigeration system 200, according to an embodiment of the present disclosure. FIG. 1b is a schematic illustration of an alternative energy management system for the transport refrigeration system 200 illustrated in FIG. 1a, according to an embodiment of the present disclosure. FIG. 2 shows an enlarged schematic illustration of the transport refrigeration system 200 of FIGS. 1a and 1b, according to an embodiment of the present disclosure.

The transport refrigeration system 200 is being illustrated as a trailer system 100, as seen in FIG. 1a. The trailer system 100 includes a vehicle 102 integrally connected to a transport container 106. The vehicle 102 includes an operator's compartment or cab 104 and an engine 320 which acts as the drive system of the trailer system 100. The engine 320 is configured to power the vehicle 102. The fuel that powers the engine 320 may be at least one of compressed natural gas, liquefied natural gas, gasoline, electricity, and diesel. The transport container 106 is coupled to the vehicle 102. The transport container 106 is a refrigerated trailer and includes a top wall 108, a directly opposed bottom wall 110, opposed side walls 112, and a front wall 114, with the front wall 114 being closest to the vehicle 102. The transport container 106 further includes a door or doors 117 at a rear wall 116, opposite the front wall 114. The walls of the transport container 106 define a refrigerated cargo space 119. It is appreciated by those of skill in the art that embodiments described herein may be applied to non-trailer refrigeration such as, for example a rigid truck or a truck having refrigerated compartment.

Typically, transport refrigeration systems 200 are used to transport and distribute perishable goods and environmentally sensitive goods (herein referred to as perishable goods 118). The perishable goods 118 may include but are not limited to fruits, vegetables, grains, beans, nuts, eggs, dairy, seed, flowers, meat, poultry, fish, ice, blood, pharmaceuticals, or any other suitable cargo requiring temperature controlled transport. The transport refrigeration system 200 includes a refrigeration unit 22, a refrigerant compression device 32, an electric motor 26 for driving the refrigerant compression device 32, and a controller 30. The refrigeration unit 22 is configured to provide conditioned air to the transport container 106. The refrigeration unit 22 functions, under the control of the controller 30, to establish and regulate a desired environmental parameters, such as, for example temperature, pressure, humidity, carbon dioxide, ethylene, ozone, light exposure, vibration exposure, and other conditions in the interior compartment 119, as known to one of ordinary skill in the art. In an embodiment, the refrigeration unit 22 is capable of providing a desired temperature and humidity range.

The refrigeration unit 22 includes a refrigerant compression device 32, a refrigerant heat rejection heat exchanger 34, an expansion device 36, and a refrigerant heat absorption heat exchanger 38 connected in refrigerant flow communication in a closed loop refrigerant circuit and arranged in a conventional refrigeration cycle. The refrigeration unit 22 also includes one or more fans 40 associated with the refrigerant heat rejection heat exchanger 34 and driven by fan motor(s) 42 and one or more fans 44 associated with the refrigerant heat absorption heat exchanger 38 and driven by fan motor(s) 46. The refrigeration unit 22 may also include a heater 48 associated with the refrigerant heat absorption heat exchanger 38. In an embodiment, the heater 48 may be an electric resistance heater. It is to be understood that other components (not shown) may be incorporated into the refrigerant circuit as desired, including for example, but not limited to, a suction modulation valve, a receiver, a filter/dryer, an economizer circuit.

The refrigerant heat rejection heat exchanger 34 may, for example, comprise one or more refrigerant conveying coiled tubes or one or more tube banks formed of a plurality of refrigerant conveying tubes across flow path to the heat outlet 142. The fan(s) 40 are operative to pass air, typically ambient air, across the tubes of the refrigerant heat rejection heat exchanger 34 to cool refrigerant vapor passing through the tubes. The refrigerant heat rejection heat exchanger 34 may operate either as a refrigerant condenser, such as if the refrigeration unit 22 is operating in a subcritical refrigerant cycle or as a refrigerant gas cooler, such as if the refrigeration unit 22 is operating in a transcritical cycle.

The refrigerant heat absorption heat exchanger 38 may, for example, also comprise one or more refrigerant conveying coiled tubes or one or more tube banks formed of a plurality of refrigerant conveying tubes extending across flow path from a return air inlet 136. The fan(s) 44 are operative to pass air drawn from the refrigerated cargo space 119 across the tubes of the refrigerant heat absorption heat exchanger 38 to heat and evaporate refrigerant liquid passing through the tubes and cool the air. The air cooled in traversing the refrigerant heat rejection heat exchanger 38 is supplied back to the refrigerated cargo space 119 through a refrigeration unit outlet 140. It is to be understood that the term “air” when used herein with reference to the atmosphere within the cargo box includes mixtures of air with other gases, such as for example, but not limited to, nitrogen or carbon dioxide, sometimes introduced into a refrigerated cargo box for transport of perishable produce.

Airflow is circulated into and through the refrigerate cargo space 119 of the transport container 106 by means of the refrigeration unit 22. A return airflow 134 flows into the refrigeration unit 22 from the refrigerated cargo space 119 through the refrigeration unit return air intake 136, and across the refrigerant heat absorption heat exchanger 38 via the fan 44, thus conditioning the return airflow 134 to a selected or predetermined temperature. The conditioned return airflow 134, now referred to as supply airflow 138, is supplied into the refrigerated cargo space 119 of the transport container 106 through the refrigeration unit outlet 140. Heat 135 is removed from the refrigerant heat rejection heat exchanger 34 through the heat outlet 142. The refrigeration unit 22 may contain an external air inlet 144, as shown in FIG. 2, to aid in the removal of heat 135 from the refrigerant heat rejection heat exchanger 34 by pulling in external air 137. The supply airflow 138 may cool the perishable goods 118 in the refrigerated cargo space 119 of the transport container 106. It is to be appreciated that the refrigeration unit 22 can further be operated in reverse to warm the container system 106 when, for example, the outside temperature is very low. In the illustrated embodiment, the return air intake 136, the refrigeration unit outlet 140, the heat outlet 142, and the external air inlet 144 are configured as grilles to help prevent foreign objects from entering the refrigeration unit 22.

The transport refrigeration system 200 also includes a controller 30 configured for controlling the operation of the transport refrigeration system 200 including, but not limited to, the operation of various components of the refrigerant unit 22 to provide and maintain a desired thermal environment within the refrigerated cargo space 119. The controller 30 may also be able to selectively operate the electric motor 26. The controller 30 may be an electronic controller including a processor and an associated memory comprising computer-executable instructions that, when executed by the processor, cause the processor to perform various operations. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be a storage device such as, for example, a random access memory (RAM), read only memory (ROM), or other electronic, optical, magnetic or any other computer readable medium.

The refrigeration unit 22 is powered by the battery 350, which provides electrical power to the refrigeration unit 22 and will be discussed further below. The refrigeration unit 22 has a plurality of electrical power demand loads on the battery 350, including, but not limited to, the drive motor 42 for the fan 40 associated with the refrigerant heat rejection heat exchanger 34, and the drive motor 46 for the fan 44 associated with the refrigerant heat absorption heat exchanger 38. As each of the fan motors 42, 46 and the electric motor 26 may be an AC motor or a DC motor, it is to be understood that various power converters 52, such as AC to DC rectifiers, DC to AC inverters, AC to AC voltage/frequency converters, and DC to DC voltage converters, may be employed in connection with the battery as appropriate. In the depicted embodiment, the heater 48 also constitutes an electrical power demand load. The electric resistance heater 48 may be selectively operated by the controller 30 whenever a control temperature within the temperature controlled cargo box drops below a preset lower temperature limit, which may occur in a cold ambient environment. In such an event the controller 30 would activate the heater 48 to heat air circulated over the heater 48 by the fan(s) 44 associated with the refrigerant heat absorption heat exchanger 38. The heater 48 may also be used to de-ice the return air intake 136. Additionally, the electric motor 26 being used to power the refrigerant compression device 32 also constitutes a demand load. The refrigerant compression device 32 may comprise a single-stage or multiple-stage compressor such as, for example, a reciprocating compressor or a scroll compressor. The transport refrigeration system 200 may also include a voltage sensor 28 to sense the voltage from the battery 350.

As described above the battery 350 may be used to electrical power the refrigeration unit 22. The battery 350 is integrated within an energy management system 300. The energy management system 300 comprises the engine 320, a hydraulic pump 330 driven by the engine 320, an electric generation device 340 driven by the hydraulic pump 330, the battery 350 configured to provide electrical power to the refrigeration unit 22, a communication interface module (CIM) 310, and a sensor system 360. The electric generation device 340 is operably connected to the engine 320 and configured to engage the engine 320 and generate electrical power from the engine 320 when the electric generation device 340 is activated. The electric generation device 340 will then use the generated electrical power to charge the battery 350. In an embodiment, as seen in FIG. 1a, the electric generation device 340 may be operably connected to the engine 320 through a hydraulic pump 330. In another embodiment, the hydraulic pump 330 may be a variable displacement hydraulic pump. In an alternate embodiment, the electric generation device 340 may be operably connected to the engine 320 through at least one mechanical linkage, such as, for example a drive shaft, belt system, or gear system. The mechanical linkage configured to rotate the electric generation device 340 as the engine rotates when the electric generation device 340 is activated. For example, a drive shaft of the engine drives a drive shaft of the electric generation device 340. The electric generation device 340 may comprise a single on-board, engine driven AC generator configured to generate alternating current (AC) power including at least one AC voltage at one or more frequencies. In an embodiment, the electric generation device 340 may, for example, be a permanent magnet AC generator or a synchronous AC generator. In another embodiment, the electric generation device 340 may comprise a single on-board, engine driven DC generator configured to generate direct current (DC) power at at least one voltage.

FIG. 1b illustrates an alternative configuration for the energy management system 300. In the embodiment of FIG. 1b, the electric generation device 340 may be a vehicle alternator. The electric generation device 340 is operably connected to the engine 320 and configured to engage the engine 320 and generate electrical power from the engine 320 when the electric generation device 340 is activated. The electric generation device 340 will then use the generated electrical power to charge the vehicle battery 382. The vehicle battery 382 is electrically connected to the power generation device 340 and configured to store the electrical power generated by the power generation device 340 then charge the battery through a voltage converter 384. The voltage convertor 384 is configured to step-up the electrical power from a first voltage of the vehicle battery 382 to a second voltage of the battery 350. The vehicle battery 382 may be a standard automotive battery having a first voltage equal to about 12 volts. As mentioned, the power within the vehicle battery 382 is then converted (stepped-up) to the voltage required to charge the battery 350 by the voltage convertor 384. In an embodiment, the second voltage of the battery 350 may be equal to about 48 volts and thus the voltage convertor 384 may be a 12V/48V DC/DC convertor. When the vehicle 102 is stationary, the battery 350 may alternatively be charged by a stationary battery charger 386 such as, for example a wall 48V power outlet.

The sensor system 360 is configured to detect at least one of a deceleration of the vehicle 102, a downward pitch of the vehicle 102, and a high-efficiency rotational speed of the engine 320. The sensor system 360 may accomplish this detection utilizing a plurality of sensors comprising: an engine rotational speed sensor 362, a vehicle deceleration sensor 364, and a vehicle pitch sensor 366, discussed further below. The communication interface module 310 is configured to activate the electric generation device 340 when the sensor system 360 detects at least one of the deceleration of the vehicle 102, the downward pitch of the vehicle 102, and the high-efficiency rotational speed of the engine 320. The sensor system 360 may also include a GPS device in order to predict in advance at least one of the deceleration of the vehicle 102, the downward pitch of the vehicle 102, and the high-efficiency rotational speed of the engine 320. The communication interface module 310 is in electrical communication with at least one of the battery 350, the electric generation device 340, the engine 320, and the sensor system 360. The communication interface module 310 may be an electronic controller including a processor and an associated memory comprising computer-executable instructions that, when executed by the processor, cause the processor to perform various operations. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be a storage device such as, for example, a random access memory (RAM), read only memory (ROM), or other electronic, optical, magnetic or any other computer readable medium.

The engine rotational speed sensor 362 is configured to detect a rotational speed of the engine 320, such as, for example the rotations per minute (RPM) of the engine. The engine rotational speed sensor 362 is in operative association with the engine 320. The engine rotation speed sensor 362 is in operative communication with the communication interphase module 310 and the communication interphase module 310 controls the operation of the engine rotational speed sensor 362. The communication interface module 310 is configured to activate the electric generation device 340 when the rotational speed is greater than a selected rotational speed, which may indicate that the engine 320 is operating at a high efficiency and it is a good time to bleed off some rotational energy of the engine 320 to charge the battery 350 using the electric generation device 340. Bleeding off rotational energy of the engine 320 when the engine 320 is operating at a high efficiency helps reduce any performance impact to the ability of the engine 320 to power the vehicle 102.

The vehicle deceleration sensor 364 is configured to detect a deceleration of the vehicle 102. The vehicle deceleration sensor 364 is in operative association with the vehicle 102 and may detect when a brake 103 of the vehicle 102 is being applied to slow the vehicle 102 and/or the vehicle 102 is decelerating without the brakes 103 being applied. The vehicle deceleration sensor 364 is in operative communication with the communication interphase module 310 and the communication interphase module 310 controls the operation of the vehicle deceleration sensor 364. The communication interface module 310 is configured to activate the electric generation device 340 when the deceleration is greater than a selected deceleration, which may indicate that some engine 320 rotation is no longer needed to drive the vehicle 102 and it is a good time to bleed off some rotational energy of the engine 320 to charge the battery 350 using the electric generation device 340. Bleeding off rotational energy of the engine 320 when the vehicle 102 is decelerating helps reduce any performance impact to the ability of the engine 320 to power the vehicle 102.

The vehicle pitch sensor 366 is configured to detect a pitch angle of the vehicle 102. The vehicle deceleration sensor 364 is in operative communication with the communication interphase module 310 and the communication interphase module 310 controls the operation of the vehicle pitch sensor 366. The communication interface module 310 is configured to activate the electric generation device 340 when the when the pitch angle is less than a selected pitch angle, which may indicate that some engine 320 rotation is no longer needed to drive the vehicle 102 and it is a good time to bleed off some rotational energy of the engine 320 to charge the battery 350 using the electric generation device 340. For example, when the vehicle 102 is descending downhill with a negative pitch angle, gravity assists in driving the vehicle downhill and the full capacity of the engine's rotational energy may no longer be needed to drive the vehicle 102. Bleeding off rotational energy of the engine 320 when the engine 320 is the vehicle 102 is descending downhill helps reduce any performance impact to the ability of the engine 320 to power the vehicle 102.

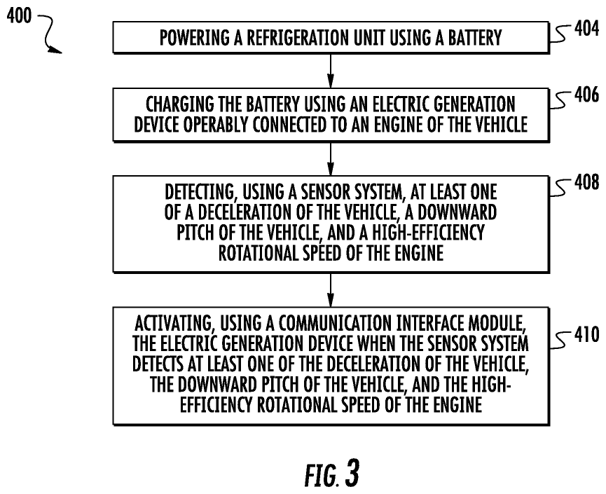

Referring now to FIG. 3, with continued reference to FIGS. 1a, 1b, and 2. FIG. 3 shows a flow process illustrating a method 400 of operating a transport refrigeration system 200 comprising a vehicle 102 integrally connected to a transport container 106, according to an embodiment of the present disclosure. At block 404, a refrigeration unit 22 powered using a battery 350. As mentioned above, the refrigeration unit 22 is configured to provide conditioned air to the transport container 106. At block 406, the battery 350 is charged using an electric generation device 340 operably connected to an engine 320 of the vehicle 102. As mentioned above, the electric generation device 340 is configured to engage the engine 320 and generate power from the engine 320 to charge the battery 350 when the electric generation device 340 is activated. At block 408, a sensor system 360 detects at least one of a deceleration of the vehicle 102, a downward pitch of the vehicle 102, and a high-efficiency rotational speed of the engine 320. At block 410, a communication interface module 310 activates the electric generation device 340 when the sensor system 360 detects at least one of the deceleration of the vehicle 102, the downward pitch of the vehicle 102, and the high-efficiency rotational speed of the engine 320. As discussed above, the communication interface module 310 is in electrical communication with at least one of the battery 350, the electric generation device 340, the engine 320, and the sensor system 360.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A transport refrigeration system comprising:
a vehicle integrally connected to a transport container; an engine configured to power the vehicle;
a refrigeration unit configured to provide conditioned air to the transport container;
a battery configured to provide electrical power to the refrigeration unit; an electric generation device operably connected to the engine and configured to engage the engine and generate electrical power from the engine to charge the battery when the electric generation device is activated;
a sensor system configured to detect at least one of a deceleration of the vehicle, a downward pitch of the vehicle, and a high-efficiency rotational speed of the engine; and
a communication interface module in electrical communication with at least one of the battery, the electric generation device, the engine, and the sensor system;
wherein the communication interface module activates the electric generation device when the sensor system detects at least one of the deceleration of the vehicle, the downward pitch of the vehicle, and the high-efficiency rotational speed of the engine.

2. The transport refrigeration system according to claim 1, further comprising:
a hydraulic pump operably connecting the electric generation device to the engine.

3. The transport refrigeration system according to claim 1, wherein: the electric generation device is operably connected to the engine through at least one mechanical linkage configured to rotate the electric generation device as the engine rotates when the electric generation device is activated.

4. The transport refrigeration system according claim 1, wherein:
the sensor system further comprises a vehicle pitch sensor, the vehicle pitch sensor being configured to detect a pitch angle of the vehicle; and
the communication interface module is configured to activate the electric generation device when the pitch angle is less than a selected pitch angle.

5. The transport refrigeration system according to claim 1, wherein:
the sensor system further comprises a vehicle deceleration sensor, the vehicle deceleration sensor being configured to detect a deceleration of the vehicle;
and
the communication interface module is configured to activate the electric generation device when the deceleration is greater than a selected deceleration.

6. The transport refrigeration system according claim 1, wherein:
the sensor system further comprises an engine rotational speed sensor, the engine rotational speed sensor being configured to detect a rotational speed of the engine; and
the communication interface module is configured to activate the electric generation device when the rotational speed is greater than a selected rotational speed.

7. The transport refrigeration system according to claim 1, further comprising:
a vehicle battery electrically connected to the power generation device, the vehicle battery being configured to store electrical power generated by the power generation device and charge the battery through a voltage converter, wherein the voltage convertor is configured to step-up the electrical power from a first voltage of the vehicle battery to a second voltage of the battery.

8. A method of operating a transport refrigeration system comprising a vehicle integrally connected to a transport container, the method comprising:
powering a refrigeration unit using a battery, the refrigeration unit being configured to provide conditioned air to the transport container;
charging the battery using an electric generation device operably connected to an engine of the vehicle, the electric generation device configured to engage the engine and generate electrical power from the engine to charge the battery when the electric generation device is activated;
detecting, using a sensor system, at least one of a deceleration of the vehicle, a downward pitch of the vehicle, and a high-efficiency rotational speed of the engine; and
activating, using a communication interface module, the electric generation device when the sensor system detects at least one of the deceleration of the vehicle, the downward pitch of the vehicle, and the high-efficiency rotational speed of the engine;
wherein the communication interface module in electrical communication with at least one of the battery, the electric generation device, the engine, and the sensor system.

9. The method according to claim 8, further comprising:
transferring rotational energy from the engine to the electric generation device through a hydraulic pump when the electric generation device is activated.

10. The method according to claim 8, further comprising:
transferring rotational energy from the engine to the electric generation device through at least one mechanical linkage configured to rotate the electric generation device as the engine rotates when the electric generation device is activated.

11. The method according to claim 8, further comprising: detecting a pitch angle of the vehicle using a vehicle pitch sensor; and activating, using the communication interface module, the electric generation device when the pitch angle is less than a selected pitch angle.

12. The method according to claim 8, further comprising: detecting a deceleration of the vehicle using a vehicle deceleration sensor;
and
activating, using the communication interface module, the electric generation device when the deceleration is greater than a selected deceleration.

13. The method according to claim 8, further comprising: detecting a rotational speed of the engine using an engine rotational speed sensor; and
activating, using the communication interface module, the electric generation device when the rotational speed is greater than a selected rotational speed.

14. The method according to claim 8, wherein:
the battery is charged through a vehicle battery electrically connected to the power generation device and a power convertor, the vehicle battery being configured to store electrical power generated by the power generation device and the voltage convertor being configured to step-up the electrical power from a first voltage of the vehicle battery to a second voltage of the battery.

15. A computer program product tangibly embodied on a computer readable medium, the computer program product including instructions that, when executed by a processor, cause the processor to perform operations comprising:
powering a refrigeration unit using a battery, the refrigeration unit being configured to provide conditioned air to a transport container;
charging the battery using an electric generation device operably connected to an engine of a vehicle integrally connected to the transport container, the electric generation device configured to engage the engine and generate electrical power from the engine to charge the battery when the electric generation device is activated;
detecting, using a sensor system, at least one of a deceleration of the vehicle, a downward pitch of the vehicle, and a high-efficiency rotational speed of the engine; and
activating, using a communication interface module, the electric generation device when the sensor system detects at least one of the deceleration of the vehicle, the downward pitch of the vehicle, and the high-efficiency rotational speed of the engine;
wherein the communication interface module in electrical communication with at least one of the battery, the electric generation device, the engine, and the sensor system.

16. The computer program according to claim 15, wherein the operations further comprise:
transferring rotational energy from the engine to the electric generation device through a hydraulic pump when the electric generation device is activated.

17. The computer program according to claim 15, wherein the operations further comprise:
transferring rotational energy from the engine to the electric generation device through at least one mechanical linkage configured to rotate the electric generation device as the engine rotates when the electric generation device is activated.

18. The computer program according to claim 15, wherein the operations further comprise:
detecting a pitch angle of the vehicle using a vehicle pitch sensor; and activating, using the communication interface module, the electric generation device when the pitch angle is less than a selected pitch angle.

19. The computer program according to claim 15, wherein the operations further comprise:
detecting a deceleration of the vehicle using a vehicle deceleration sensor; and
activating, using the communication interface module, the electric generation device when the deceleration is greater than a selected deceleration.

20. The computer program according to claim 15, wherein the operations further comprise:
detecting a rotational speed of the engine using an engine rotational speed sensor; and
activating, using the communication interface module, the electric generation device when the rotational speed is greater than a selected rotational speed.
